(19) United States
(12) Patent Application Publication
(10) Pub. No.: US 2020/0159183 A1
(43) Pub. Date: May 21, 2020

(54) QUALITY ANALYSIS DEVICE AND QUALITY ANALYSIS METHOD

(71) Applicant: Mitsubishi Electric Corporation, Tokyo (JP)

(72) Inventor: Takafumi UEDA, Tokyo (JP)

(73) Assignee: Mitsubishi Electric Corporation, Tokyo (JP)

(21) Appl. No.: 16/626,716

(22) PCT Filed: Jul. 19, 2017
(86) PCT No.: PCT/JP2017/026108

§ 371 Date: Dec. 26, 2019

(51) Int. Cl. G05B 19/406

(52) U.S. Cl. CPC G05B 19/406; G05B 2219/37229

(57) ABSTRACT

A data aggregation unit acquires quality data and apparatus-information data. With respect to the quality data and the apparatus-information data acquired by the data aggregation unit, a condition setting unit sets data items of data to be counted up, a base condition indicating a condition that constitutes a basis of quality analysis, and a comparison condition indicating a condition subjected to the quality analysis. A distribution difference calculation unit extracts from the quality data and the apparatus-information data acquired by the data aggregation unit, data that meets the base condition and data that meets the comparison condition, for each of the data items set by the condition setting unit, and calculates frequency distributions of these data for each of the data items, and outputs data indicating a degree of divergence between the frequency distribution of the base condition and the frequency distribution of the comparison condition.

### TECHNICAL FIELD

The present invention relates to a quality analysis device and a quality analysis method which make it possible to estimate a factor causing a change in trend of products in their manufacturing process or testing process, or a factor causing trouble of the product.

### BACKGROUND ART

In many cases, a factor that has caused trouble at a manufacturing site (variation in quality, deterioration in yield, degradation in takt time, increase of defective products, failure of an apparatus, or the like) is found depending on knowledge and experience at the manufacturing site. When a trouble factor candidate is extracted on the basis of the knowledge and experience at the manufacturing site, a problem remains that it is unclear whether the trouble factor candidate is the true trouble factor.

In order to extract a trouble factor, it is effective to employ, as quality data indicating states of products, information acquired from sensors included in a manufacturing apparatus and a test apparatus at the manufacturing site, such as, a manufacturing condition, a test condition and a test result of the products. The apparatuses at the manufacturing site are configured with many sensors and, by each of these sensors, a value corresponding to that sensor, such as a value of a current, a temperature or the like, is acquired as quality data. Here, a type of the quality data corresponding to the sensor, such as a current, a temperature or the like, is referred to as a data item.

Heretofore, as a device for analyzing a quality of a product on the basis of information from such sensors, there has been provided a device in which, for each of the data items, the quality data of products with occurrence of trouble and the quality data of products with no occurrence of trouble are visualized as frequency distributions to be compared with each other (see, for example, Patent Literature 1). Conventionally, using such a device, an operator confirms the compared results and then, when there is a data item with which the difference changes to become large, judges that data item to be a trouble factor candidate.

### CITATION LIST

### Patent Literature

Patent Literature 1: Japanese Patent Application Laid-open No. 2008-181341

### SUMMARY OF INVENTION

### Technical Problem

Conventionally, using such a quality analysis device as described in Patent Literature 1, the frequency distribution of the quality data associated with the occurrence of trouble and the frequency distribution of the quality data associated with no occurrence of trouble are compared with each other, so that a candidate causing trouble at the manufacturing site is extracted in such a manner as to specify a data item at which a feature of trouble appears.

However, according to the conventional quality analysis device, since it is based on the premise that trouble has occurred, it is difficult to extract quality data showing a gradual change which is not enough to cause trouble. If trouble has occurred, extraction of a trouble factor according to the comparison between the frequency distributions is relied on an analyst who confirms the frequency distributions, so that his/her load for confirmation becomes higher as the number of data items increases. Further, if some difference occurs between the frequency distributions, estimation of the reason of occurrence of the difference is, in many cases, qualitatively judged depending on the operator's experience, so that it is difficult to specify a trouble factor.

This invention has been made to solve such problems, and an object thereof is to provide a quality analysis device and a quality analysis method which can speed up the extraction of a trouble factor candidate and can easily predict occurrence of trouble.

### Solution to Problem

A quality analysis device according to the invention includes a data aggregation unit for acquiring quality data indicating a state of an object subjected to quality analysis and apparatus-information data indicating information of an apparatus that handles the object subjected to quality analysis, a condition setting unit for setting, with respect to the quality data and the apparatus-information data acquired by the data aggregation unit, data items of data to be counted up, a base condition indicating a condition that constitutes a basis of the quality analysis, and a comparison condition indicating a condition subjected to the quality analysis; and a distribution difference calculation unit for extracting from the quality data and the apparatus-information data acquired by the data aggregation unit, data that meets the base condition and data that meets the comparison condition, for each data item set by the condition setting unit, and calculating frequency distributions of these data for each of the data items, and outputting data indicating a degree of divergence between the frequency distribution of the base condition and the frequency distribution of the comparison condition.

### Advantageous Effects of Invention

The quality analysis device according to the invention is configured to set the data items, the base condition and the comparison condition that are subjected to the quality analysis, and to output, for each of the data items, data indicating the degree of divergence provided between the base condition and the comparison condition. This makes it possible to rapidly extract a trouble factor candidate and to easily predict occurrence of trouble.

### BRIEF DESCRIPTION OF DRAWINGS

FIG. 1 is a configuration diagram showing a quality analysis device of Embodiment 1 of the invention.

FIG. 2 is a hardware configuration diagram of the quality analysis device of Embodiment 1 of the invention.

FIG. 3 is an illustration diagram showing an example of quality data from the quality analysis device of Embodiment 1 of the invention.

FIG. 4 is an illustration diagram showing an example of apparatus-information data from the quality analysis device of Embodiment 1 of the invention.

FIG. 5 is an illustration diagram showing an example of data classified by a data-type classification unit in the quality analysis device of Embodiment 1 of the invention.

FIG. 6 is a flowchart showing operations of a condition setting unit and a distribution difference calculation unit in the quality analysis device of Embodiment 1 of the invention.

FIG. 7 is an illustration diagram showing a screen on which conditions are set, in the quality analysis device of Embodiment 1 of the invention.

FIG. 8 is an illustration diagram showing data outputted from the distribution difference calculation unit in the quality analysis device of Embodiment 1 of the invention.

FIG. 9 is a configuration diagram showing a quality analysis device of Embodiment 2 of the invention.

FIG. 10 is an illustration diagram showing event data from the quality analysis device of Embodiment 2 of the invention.

FIG. 11 is a flowchart showing operations of an event-effect analysis unit in the quality analysis device of Embodiment 2 of the invention.

FIG. 12 is an illustration diagram showing an example of values of a factor candidate according to trend waveforms of that factor candidate, in the quality analysis device of Embodiment 2 of the invention.

FIG. 13 is an illustration diagram showing the trend waveforms based on the values in FIG. 12, in the quality analysis device of Embodiment 2 of the invention.

FIG. 14 is an illustration diagram showing an example in which trend waveforms and event data are correlated with each other on a closest date basis, in the quality analysis device of Embodiment 2 of the invention.

FIG. 15 is an illustration diagram showing the values in FIG. 14 as waveforms, in the quality analysis device of Embodiment 2 of the invention.

### DESCRIPTION OF EMBODIMENTS

Hereinafter, for illustrating the invention in more detail, embodiments for carrying out the invention will be described with reference to accompanying drawings.

### Embodiment 1

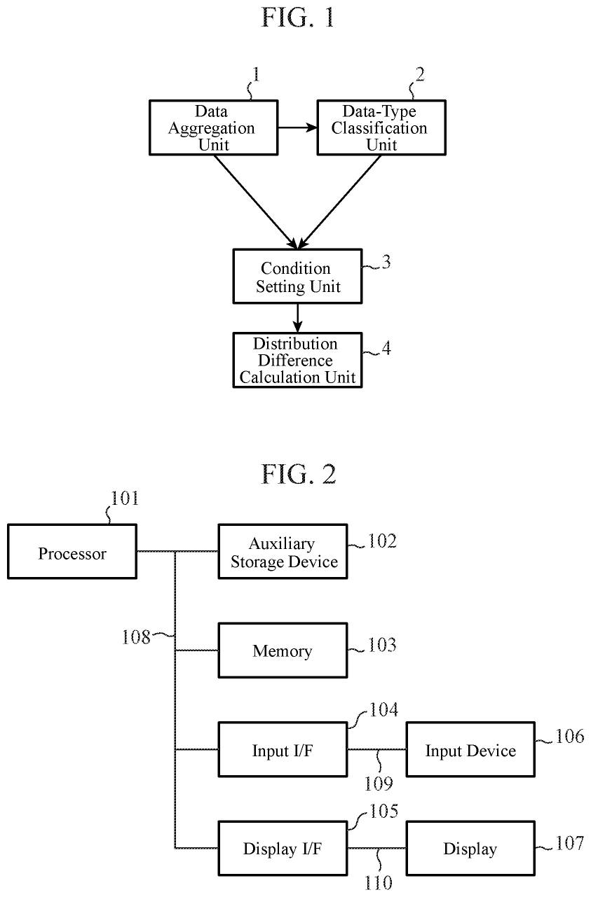

FIG. 1 is a configuration diagram of a quality analysis device according to this embodiment.

The quality analysis device according to this embodiment includes a data aggregation unit 1, a data-type classification unit 2, a condition setting unit 3 and a distribution difference calculation unit 4. The data aggregation unit 1 is a processing unit that acquires quality data and apparatus-information data. The data-type classification unit 2 is a processing unit that classifies the quality data and the apparatus-information data acquired by the data aggregation unit 1, in accordance with a predetermined specific rule. The condition setting unit 3 is a processing unit that sets, with respect to these data acquired by the data aggregation unit 1 or the data classified by the data-type classification unit 2, data items of data to be counted up; a base condition indicating a condition that constitutes a basis of quality analysis; and a comparison condition indicating a condition subjected to the quality analysis. The distribution difference calculation unit 4 is a processing unit that extracts from these data acquired by the data aggregation unit 1 or the data classified by the data-type classification unit 2, respective sets of data that meet the conditions set by the condition setting unit 3, and calculates their frequency distributions for each of the data items, and then outputs data indicating each degree of divergence between the data corresponding to the base condition and the data corresponding to the comparison condition.

FIG. 2 is a hardware configuration diagram of the quality analysis device of Embodiment 1.

The illustrated quality analysis device is configured with a computer, and includes a processor 101; an auxiliary storage device 102; a memory 103; an input interface (input I/F) 104; a display interface (display I/F) 105; an input device 106; a display 107; a signal line 108; and cables 109, 110. The processor 101 is connected through the signal line 108 to other hardware. The input I/F 104 is connected through the cable 109 to the input device 106. The display I/F 105 is connected through the cable 110 to the display 107.

The functions of the respective functional units in the quality analysis device are implemented by software, firmware or a combination of software and firmware. The software or the firmware is written as programs and stored in the auxiliary storage device 102. These programs serve to cause the computer to execute steps or processes of the respective functional units. The processor 101 reads out and executes programs stored in the auxiliary storage device 102, to thereby implement the functions of the units from the data aggregation unit 1 to the distribution difference calculation unit 4 in FIG. 1. Further, the time-series data is also stored in the auxiliary storage device 102. Furthermore, output data of the frequency distributions or the like, may be stored in the auxiliary storage device 102.

The programs stored in the auxiliary storage device 102, the quality data and the apparatus-information data, are loaded into the memory 103, so that the processor 101 reads them thereby to implement the respective functions and to execute respective corresponding processes. The execution result is written in the memory 103 and is then stored as output data in the auxiliary storage device 102 or outputted through the display I/F 105 to an output device exemplified by the display 107.

The input device 106 is used for inputting the quality data and the apparatus-information data; for inputting parameters such as, a counting target, the comparison condition, the base condition and the like; and for inputting a start request for processing of the quality data, and the like. The inputted data received by the input device 106 is stored through the input I/F 104 in the auxiliary storage device 102. The start request received by the input device 106 is inputted through the input I/F 104 to the processor 101.

Next, operations of the quality analysis device of Embodiment 1 will be described.

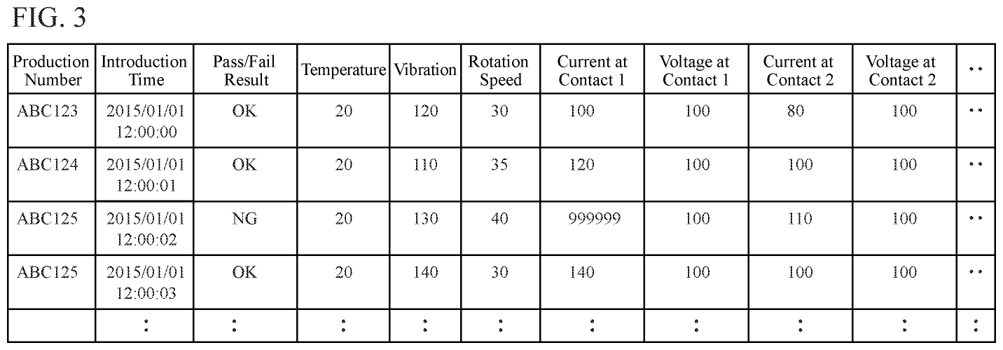

The data aggregation unit 1 acquires the quality data and the apparatus-information data. FIG. 3 is an example of the quality data. In FIG. 3, as an example of the data items of the quality data, “Production Number”, “Date & Time at Which Product Has Been Introduced into Apparatus (that is, Introduction Time)”, “Pass/Fail Result Indicating Acceptance or Rejection”, “Temperature”, “Vibration”, “Rotation Speed”, “Current at Contact 1”, “Voltage at Contact 1”, “Current at Contact 2”, “Voltage at Contact 2”, etc. are shown. Here, the data items of “Temperature”, “Vibration” and the like mean the followings. For example, in the test of a product having a rotation mechanism, its parts in conformity with the product specification are subjected to measurement while a load is being applied to the product. In that measurement, the temperature of the product, the vibration, the rotation speed, the currents flowing through the given parts (Contact 1, Contact 2, and the like) and their voltages, at the time the load is applied, are measured. The data items of “Current at Contact 1” and “Voltage at Contact 1” in FIG. 3 indicate a current value and a voltage value at the given part under testing.

The quality data is data indicating states of the products as the objects subjected to the quality analysis, and is thus an aggregation of values acquired every time each of the products is manufactured or inspected. The quality data may be recorded in any type of device and, for example, it is data that is accumulated in an apparatus in the factory line, or a supervision system for controlling an apparatus. It may instead be data that is accumulated in a product management system for managing the test results of the product inspection.

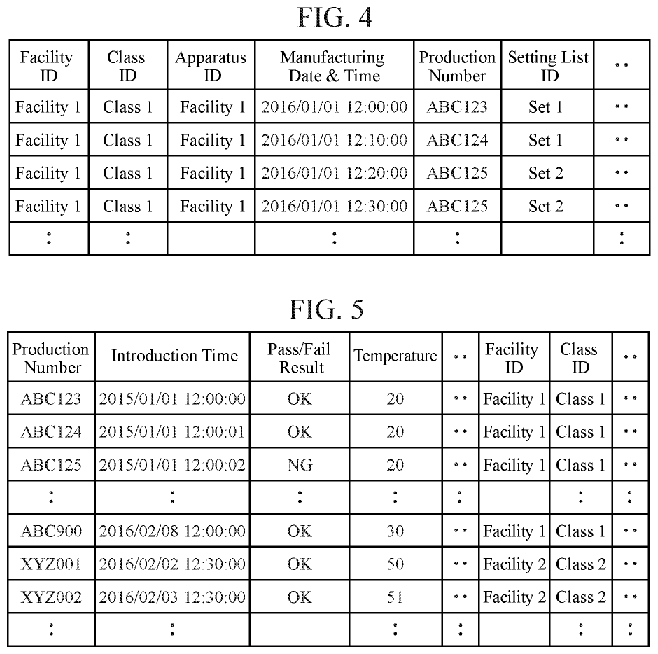

FIG. 4 shows an example of the apparatus-information data. In FIG. 4, as an example of the data items of the apparatus-information data, “Facility ID”, “Class ID”, “Apparatus ID”, “Manufacturing Date & Time”, “Production Number”, “Setting Information in Manufacturing (that is, Setting List ID)”, etc. are shown. Note that “Apparatus ID” is identification information for each apparatus, “Class ID” is identification information indicating a class of each apparatus, and “Facility ID” is identification information indicating what class of the apparatus the facility is configured with. Further, “Setting List ID” is information for identifying each piece of setting information for the apparatus, such as, reference values (respective upper and lower limit values) used for the product manufacturing condition or the product inspection. The apparatus-information data is data indicating information of the apparatus that handles the products as objects subjected to the quality analysis, and thus comprises a sequence, or time-series data, of values acquired every time the product is manufactured. The time-series data is a sequence of values obtained through sequential measurements by lapse of time. The time-series data may be of any type and, for example, it is time-series data accumulated in a control system for controlling a manufacturing apparatus including, for example, a processing machine, a robot, a pump and the like. It may be data accumulated in an apparatus in the manufacturing line or the test line of the factory.

In each of FIG. 3 and FIG. 4, the data is written in a single table; however, the facility or apparatus-related data may be divided into multiple tables if it is possible to associate each apparatus with each of the tables.

In the data-type classification unit 2, for each of the data items of the data aggregated by the data aggregation unit 1, names, IDs or the like are stored that are each identifiable as the data item. These identifiable names, IDs and the like for each of the data items, may be estimated from the serial numbers or values of the data item, or may be manually defined from the outside. FIG. 5 shows an example in which respective data items of the data aggregated by the data aggregation unit 1 are consolidated to thereby prepare a table. This table may be a sheet of a spreadsheet application, or a table in a database.

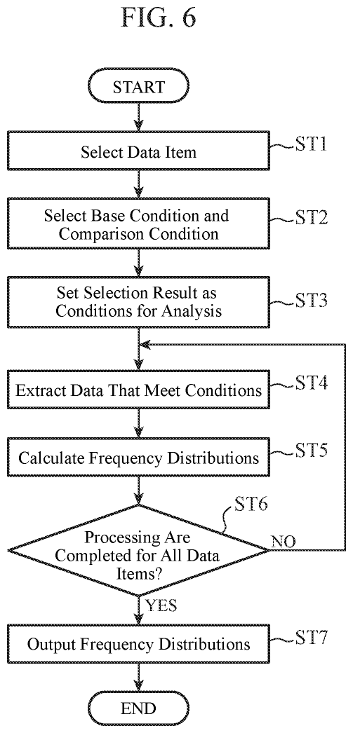

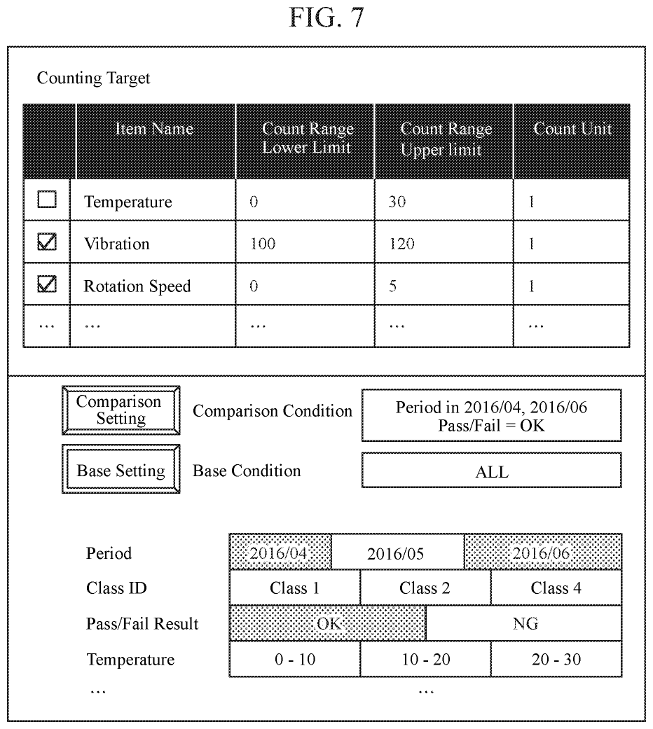

Next, operations of the condition setting unit 3 and the distribution difference calculation unit 4 will be described. FIG. 6 is a flowchart showing the operations of the condition setting unit 3 and the distribution difference calculation unit 4. Further, FIG. 7 is an illustration diagram showing the conditions set by the condition setting unit 3.

The condition setting unit 3 selects as conditions for analysis, three categories of:
data items and respective upper and lower limit values therefor, subjected to frequency-distribution calculation (counting target);
a data item(s) and a value(s) thereof, used for the comparison condition; and
a data item(s) and a value(s) thereof, used for the base condition; (Steps ST1, ST2)

and then sets the selection result (Step ST3).

The comparison condition and the base condition may be automatically classified by a clustering method as shown in FIG. 7. Instead, they may be predefined manually or these conditions may be manually written like queries for a database. When they are to be defined from the outside, their corresponding values are inputted through the input device 106 in FIG. 2, so that the processor 101 performs processing corresponding to the condition setting unit 3 to thereby cause the auxiliary storage device 102 to store the conditions for analysis.

The example shown in FIG. 7 corresponds to a condition setting for extracting records that meet respective conditions about “Vibration” and “Rotation Speed”. Examples of queries for obtaining values of the respective data items will be shown below.
Counting Target: The value of “Vibration” is 100 to 120, and the value of “Rotation Speed” is 0 to 50
Comparison Condition: Period in 2016/4 and 2016/6, and Pass/Fail Result=OK
The query of “Vibration” that meets the comparison condition:

### SELECT VIBRATION FROM DATA-TYPE CLASSIFICATION TABLE

WHERE VIBRATION BTWEEN 100 AND 120 AND

INTRODUCTION TIME=2016/4 OR INTRODUCTION TIME=2016/6 AND

PASS/FAIL RESULT=OK
The query of “Rotation Speed” that meets the comparison condition:

### SELECT ROTATION SPEED FROM DATA-TYPE CLASSIFICATION TABLE

WHERE ROTATION SPEED BTWEEN 0 AND 50 AND

INTRODUCTION TIME=2016/4 OR INTRODUCTION TIME=2016/6 AND

PASS/FAIL RESULT=OK
Base Condition: ALL
The query of “Vibration” that meets the base condition:

### SELECT VIBRATION FROM DATA-TYPE CLASSIFICATION TABLE

WHERE VIBRATION BTWEEN 100 AND 120
The query of “Rotation Speed” that meets the base condition:

### SELECT ROTATION SPEED FROM DATA-TYPE CLASSIFICATION TABLE

WHERE ROTATION SPEED BTWEEN 0 AND 50

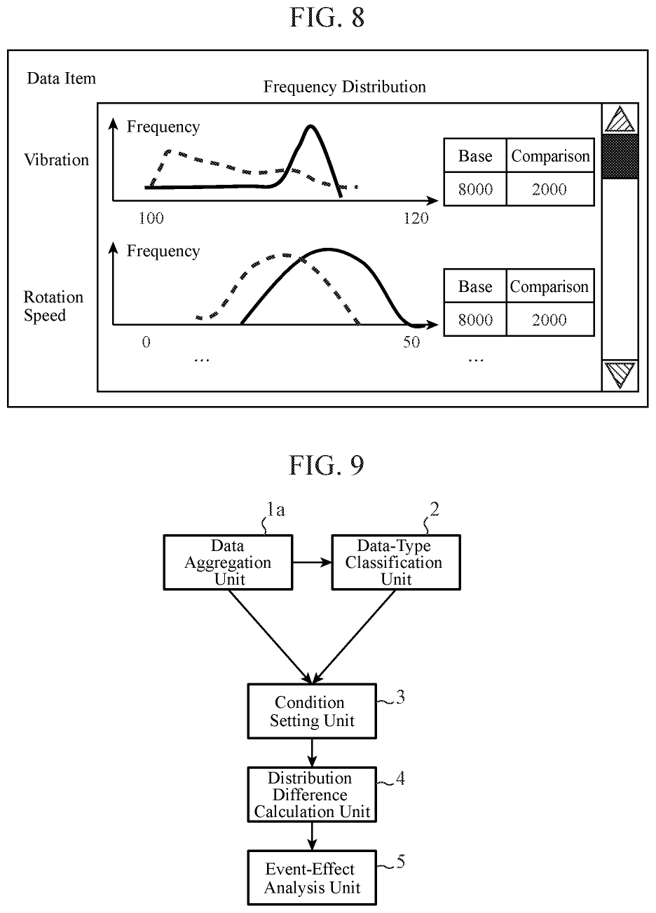

Further, in FIG. 7, “Count Unit” means a unit of count in the frequency distribution. It is a unit corresponding to one scale in the abscissa axis of the frequency distribution of FIG. 8 described later. Furthermore, among the contents of “Period”, “Class ID”, “Pass/Fail Result” and “Temperature” in this display example, “2016/04”, “2016/06” and “OK” that are shown in a shaded manner, indicate the selected condition.

The distribution difference calculation unit 4 extracts from the data aggregated by the data-type classification unit 2, data that meets the “comparison condition” and calculates its frequency distribution so that the area thereof is kept to 1, for each of the “data items in the counting target” set by the condition setting unit 3 (Step ST4, Step ST5). Each frequency distribution that meets the comparison condition is referred to as a comparison distribution. Likewise, the distribution difference calculation unit extracts data that meets the “base condition” and calculates its frequency distribution so that the area thereof is kept to 1. Each frequency distribution that meets the base condition is referred to as a base distribution. Then, the base distribution and the comparison distribution are outputted in a superimposed manner. These processes (Steps ST4 and ST5) are applied for every data item (Step ST6—“NO” Loop), and when the processes are completed for all of the data items (Step ST6—“YES”), each set of the base distribution and the comparison distribution for each of the data items in the counting target, is outputted (Step ST7). This is exemplified by FIG. 8. In FIG. 8, the abscissa represents a number of cases and the ordinate represents a frequency. The sold line indicates the base distribution and the broken line indicates the comparison distribution. Further, “Base is 8000” and “Comparison is 2000” means that the number of cases corresponding to the base condition is 8000, and that corresponding to the comparison condition is 2000.

It is conceivable that the data item in which the divergence between the base distribution and the comparison distribution in the output by the distribution difference calculation unit 4 is largest, is highly likely to be a trouble-causing factor. In the example of FIG. 8, since the degree of divergence at “Vibration” is highest, it can be thought that “Vibration” is highly likely to be a trouble-causing factor.

Further, it is allowable that, at the time of outputting, a distance between the peak of the base distribution and the peak of the comparison distribution is calculated for each of the data items, and respective sets of these distributions are outputted after being rearranged in descending order of the degree of divergence. Further, the number of samples in the base distribution and respective sizes of populations for the comparison distribution may be outputted.

In this manner, according to the quality analysis device of Embodiment 1, it is possible to quantitatively and rapidly extract a trend of the quality data or the apparatus-information data, regardless of whether trouble has occurred or not. For example, when, for each of several data items, its data in a period after the maintenance of the apparatus during which the products have been manufactured normally is compared with its latest data, it is possible to rapidly determine whether the present situation is normal or not. This is represented by the case, as an example, where the base condition is set to a “normal operation period just after the maintenance” and the comparison condition is set to a “latest period desired to be compared”. Here, let's assume that the current date is 2016 May 1, and that the maintenance is executed 2016 Apr. 1 and thereafter the apparatus has operated normally for a week without causing any problem. In that case, the base condition is set to from 2016 Apr. 1 to 2016 Apr. 8. As the latest data corresponding to the comparison condition, data in any desired period other than the normal operation period is used.

In addition, when such a data item is found in which the degree of divergence between the base distribution and the comparison distribution is large, it is possible to take measures to deal with that situation before it causes trouble.

As described above, according to the quality analysis device of Embodiment 1, the device includes the data aggregation unit for acquiring the quality data indicating a state of an object subjected to quality analysis and the apparatus-information data indicating information of an apparatus that handles the object subjected to quality analysis; the condition setting unit for setting, with respect to the quality data and the apparatus-information data acquired by the data aggregation unit, the data items of data to be counted up, the base condition indicating a condition that constitutes a basis of the quality analysis, and the comparison condition indicating a condition subjected to the quality analysis; and the distribution difference calculation unit for extracting from the quality data and the apparatus-information data acquired by the data aggregation unit, data that meets the base condition and data that meets the comparison condition, for each of the data items set by the condition setting unit, and calculating frequency distributions of these data for each of the data items, and then outputting data indicating a degree of divergence between frequency distribution corresponding to the base condition and frequency distribution corresponding to the comparison condition. Thus, it is possible to rapidly extract a trouble factor candidate and to easily predict occurrence of trouble.

Further, according to the quality analysis device of Embodiment 1, it further comprises the data-type classification unit for classifying the quality data and the apparatus-information data acquired by the data aggregation unit, into respective set types; wherein the distribution difference calculation unit uses data classified by the data-type classification unit, instead of the quality data and the apparatus-information data acquired by the data aggregation unit. Thus, it is possible to extract a trouble factor candidate, more rapidly.

Further, according to the quality analysis device of Embodiment 1, the condition setting unit sets the data items, the base condition and the comparison condition, according to data items, a base condition and a comparison condition which are indicated from outside. Thus, it is possible to easily set any given data items, base condition and comparison condition.

Further, according to the quality analysis method of Embodiment 1, the method includes: a data aggregation step in which the data aggregation unit acquires the quality data indicating a state of an object subjected to quality analysis and the apparatus-information data indicating information of an apparatus that handles the object subjected to quality analysis; a condition setting step in which, with respect to the quality data and the apparatus-information data acquired in the data aggregation step, the condition setting unit sets, the data items of data to be counted up; the base condition indicating a condition that constitutes a basis of the quality analysis; and the comparison condition indicating a condition subjected to the quality analysis; and a distribution difference calculation step in which the distribution difference calculation unit extracts from the quality data and the apparatus-information data acquired in the data aggregation step, data that meets the base condition and data that meets the comparison condition, for each of the data items set in the condition setting step, and calculates frequency distributions of these data for each of the data items, and then outputs data indicating a degree of divergence between frequency distribution corresponding to the base condition and frequency distribution corresponding to the comparison condition. Thus, it is possible to rapidly extract a trouble factor candidate and to easily predict occurrence of trouble.

### Embodiment 2

Embodiment 2 is an embodiment in which event data indicating what event has occurred in relation to the apparatus, is also included in the data to be acquired by the data aggregation unit 1, so that a relationship between values of the data item extracted in Embodiment 1 and the event data, is obtained.

Namely, the data item with a high degree of divergence between the respective data corresponding to the base condition and the comparison condition extracted by the distribution difference calculation unit 4, corresponds to a phenomenon which is highly likely to have caused trouble (hereinafter, referred to as a factor candidate) but is statistically obtained sufficiently from the quality data and the apparatus-information data. Thus, in Embodiment 2, the event data, that is conventionally to be confirmed by an expert, is correlated with aggregated values corresponding to OK/NG changes or statistics of the factor candidate. This makes it possible to obtain a result equivalent to that obtained when the knowledge of the expert is reflected. Note that, here, the expert means a person acquainted with the manufacturing steps or testing steps of the product, and indicates, for example, an experienced operator, a designer of the manufacturing apparatus, or the like.

FIG. 9 is a configuration diagram showing a quality analysis device of Embodiment 2. The illustrated quality analysis device includes: a data aggregation unit 1a; a data-type classification unit 2; a condition setting unit 3; a distribution difference calculation unit 4; and an event-effect analysis unit 5. The data aggregation unit 1a acquires quality data and apparatus-information data similarly to the data aggregation unit 1 in Embodiment 1, and further acquires event data indicating what event has occurred in relation to the apparatus. The event-effect analysis unit 5 is a processing unit for specifying the data item in which the degree of divergence by the distribution difference calculation unit 4 is equal to or more than a set value, as a factor candidate that may have caused trouble, and then outputting data indicating a relationship between values of the factor candidate in a specified period of time and event occurrence dates. Note that, since the units from the data-type classification unit 2 to the distribution difference calculation unit 4 are configured similarly to those in Embodiment 1, the same reference numerals are given to the corresponding parts, so that description thereof will be omitted.

Further, the hardware configuration of the quality analysis device of Embodiment 2 is similar to the configuration shown in FIG. 2. However, in addition to having the configuration of Embodiment 1, the quality analysis device is configured so as to implement the function corresponding to the data aggregation unit 1a and the function corresponding to the event-effect analysis unit 5, using the processor 101, the auxiliary storage device 102 and the memory 103.

Next, operations of the quality analysis device of Embodiment 2 will be described.

First, the data aggregation unit 1a acquires the event data in addition to the quality data and the apparatus-information data.

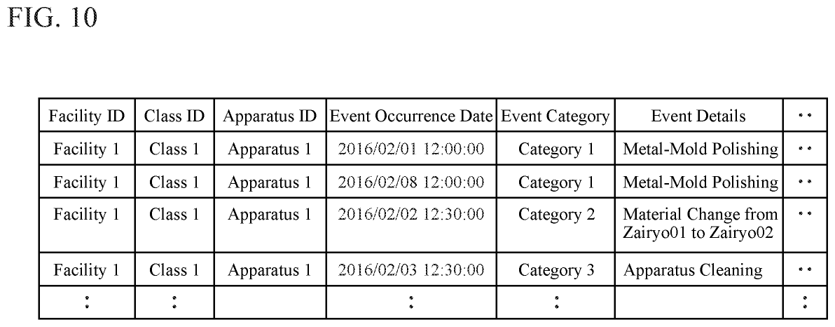

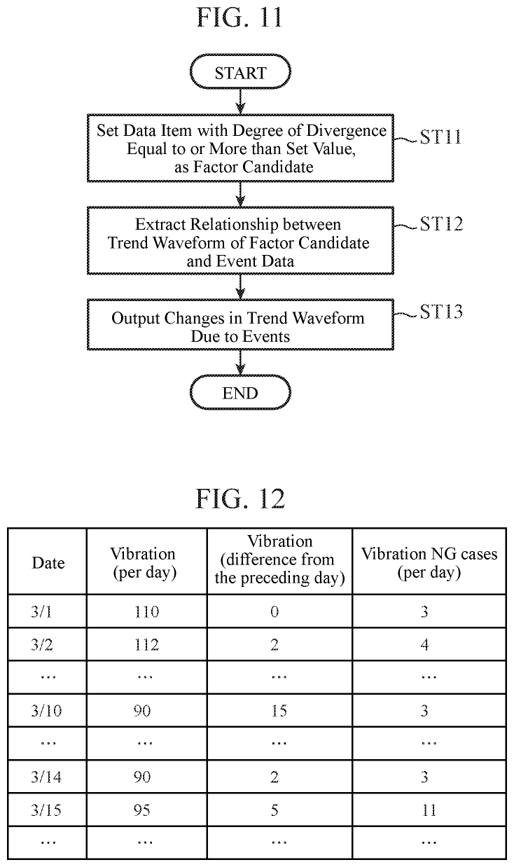

FIG. 10 is an illustration diagram showing an example of the event data. In this example, as data items, “Facility ID”, “Class ID”, “Apparatus ID”, “Event Occurrence Date”, “Event Category”, “Event Detail”, . . . are shown. “Event Occurrence Date” means the date & time at which the event has occurred, and “Event Category” means information indicating the type of the event. For example, at every manufacturing site, various types of events will occur, such as, for example, “Maintenance of Apparatus”, “Cleaning of Apparatus”, “Change in Supplier”, “Change in Material Specification”, “Change in Person in Charge” and the like, and in this diagram, as an example, metal-mold polishing (one item of the apparatus maintenance) is categorized as “Event Category 1” and the material replacement is categorized as “Event Category 2”. Further, “Event Detail” is information indicating a specific content of the event.

Processing for the data indicating the degree of divergence between the respective data corresponding to the base condition and the comparison condition, using the quality data and the apparatus-information data acquired by the data aggregation unit 1a, is similar to that in Embodiment 1. Namely, the processing by the data-type classification unit 2, the condition setting unit 3 and the distribution difference calculation unit 4 is similar to that in Embodiment 1, so that description thereof will be omitted here.

FIG. 1l1 is a flowchart showing operations of the event-effect analysis unit 5.

First, the event-effect analysis unit 5 specifies the data item in which the degree of divergence is equal to or more than a set value, as a factor candidate (Step ST11). Then, a relationship between changes in a trend waveform of the factor candidate and the event data is extracted (Step ST12). The trend waveform of the factor candidate comprises, for example, a group of values as represented by the following.
Values of the factor candidate,
Values aggregated as statistics such as averages, standard deviations or the like in a specified period of time such as every day or every month, each obtained from values of the factor candidate,
Numbers of OK/NG cases about the factor candidate aggregated in a specified period of time such as every day or every month, or
Mutual differences of values aggregated as statistics such as averages, standard deviations or the like in a specified period of time such as every day or every month, each obtained from values of the factor candidate.

The event-effect analysis unit 5 correlates the trend waveform and the event data with each other on the basis of dates and facility information that are common between these two data, to thereby output the changes in the trend waveform due to the events (Step ST13).

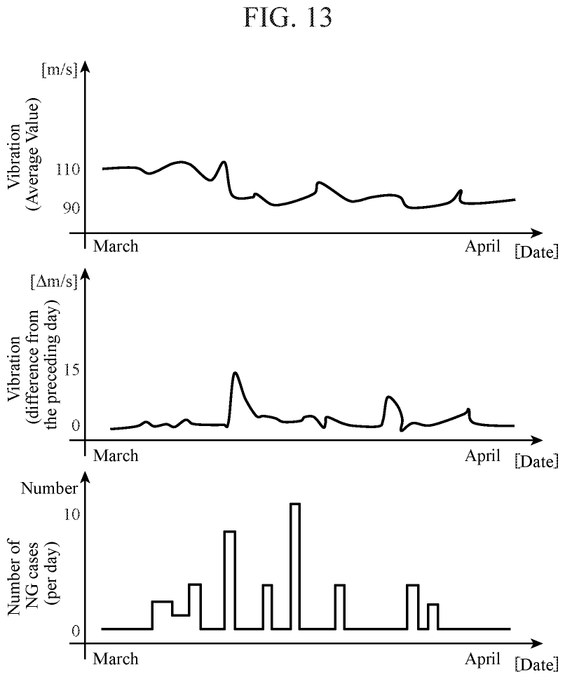

FIG. 12 shows an example of the values of the factor candidate according to trend waveforms of the factor candidate, and FIG. 13 shows graphs of the trend waveforms based on the values in FIG. 12. In relation to the data in which the average value of vibration per day changes in the first half of March, a peak occurs in the difference of the average value of vibration per day from that of the preceding day, in the first half of March. Further, with respect to the number of NG cases, a peak occurs in mid-March.

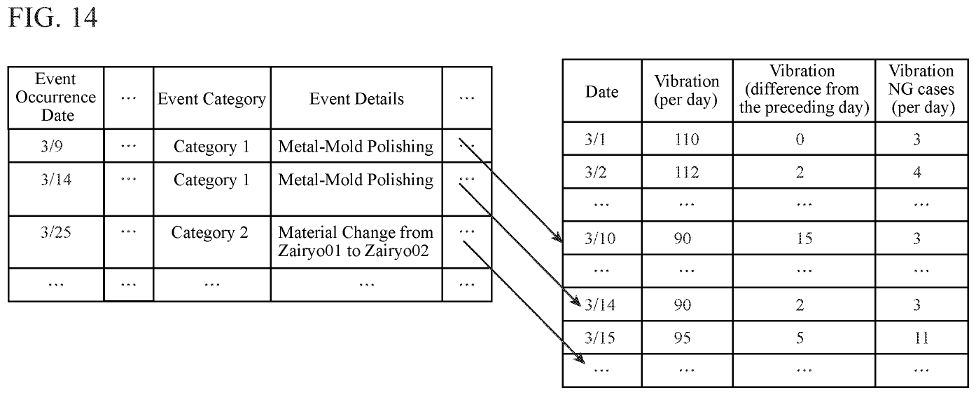

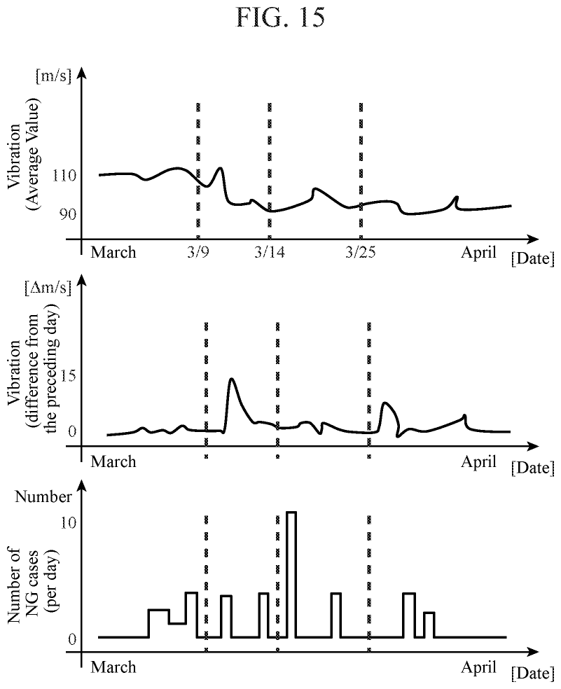

FIG. 14 is an example in which the trend waveforms and the event data are correlated with each other on a closest date basis. FIG. 15 shows graphs thereof. In FIG. 15, the broken lines indicate the event occurrence dates. In this example, as shown in FIG. 15, just after the event occurrence date of March 2014, the number of vibration-NG cases increases, so that the event on March 2014 can be estimated to be a factor that caused trouble.

It is noted that the trend waveforms and the event data may be correlated with each other on the basis of the data item other than the event occurrence date. For example, when they are correlated with each other based on the event category, it is possible to determine by what event category (type of the event) the trend varied. As an example, such a case may arise where it is confirmed whether, in the trend waveform, an analogous change occurs always just after the occurrence of “Event Category 1”. Let's assume the case where, even if a change in trend occurs in each of the majority of sections after every execution of a given event, such a change does not occur only in a certain section. When such a section or event is found, it is possible to estimate that some abnormality has occurred in that section or the event itself is defective.

As described above, according to the quality analysis device of Embodiment 2, the data aggregation unit acquires event data indicating what event(s) has(have) occurred in relation to the apparatus; and the quality analysis device further comprises the event-effect analysis unit for specifying the data item in which the degree of divergence by the distribution difference calculation unit is equal to or more than a set value, as a factor candidate that may have caused trouble, and then outputting data indicating a relationship between values of the factor candidate in a specified period of time and the event data.

Thus, it is possible to recognize not only the cause of change in trend about the factor candidate, but also the trend change timing and the event related to the change in the trend. This makes it possible to quantitatively and rapidly specify the cause for the factor candidate. Further, when the change (effect) in trend about the factor candidate due to an event is quantified, it will be possible to confirm a trend in a planned way after that event.

It should be noted that unlimited combination of the respective embodiments, modification of any configuration element in the embodiments and omission of any configuration element in the embodiments may be made in the present invention without departing from the scope of the invention.

### INDUSTRIAL APPLICABILITY

As described above, the quality analysis device and the quality analysis method according to the invention relate to a configuration which makes it possible to estimate a factor causing a change in trend of products in their manufacturing process or testing process, or a factor causing trouble of the product; and are thus suited for predicting trouble of the product under a set condition.

### REFERENCE SIGNS LIST

1, 1a: data aggregation unit, 2: data-type classification unit, 3: condition setting unit, 4: distribution difference calculation unit, 5: event-effect analysis unit, 101: processor, 102: auxiliary storage device, 103: memory, 104: input I/F, 105: display I/F, 106: input device, 107: display, 108: signal line, 109, 110: cable.

1. A quality analysis device, comprising:
processing circuitry
to acquire quality data indicating a state of an object subjected to quality analysis and apparatus-information data indicating information of an apparatus that handles the object subjected to quality analysis;
to set, with respect to the acquired quality data and the acquired apparatus-information data, data items of data to be counted up, a base condition indicating a condition that constitutes a basis of the quality analysis, and a comparison condition indicating a condition subjected to the quality analysis; and
to extract from the acquired quality data and the acquired apparatus-information data, data that meets the base condition and data that meets the comparison condition, for each set data item, and calculating frequency distributions of these data for each of the data items, and outputting data indicating a degree of divergence for each of the data items between the frequency distribution of the base condition and the frequency distribution of the comparison condition.

2. The quality analysis device of claim 1, wherein the processing circuitry further classifies the acquired quality data and the acquired apparatus-information data, into respective set types;
wherein the processing circuitry uses classified data, instead of the acquired quality data and the acquired apparatus-information data.

3. The quality analysis device of claim 1,
wherein the processing circuitry sets the data items, the base condition and the comparison condition, in accordance with data items, a base condition and a comparison condition which are indicated from outside.

4. The quality analysis device of claim 1,
wherein the processing circuitry acquires event data indicating what event has occurred in relation to the apparatus,
the processing circuitry specifies the data item in which the degree of divergence is equal to or more than a set value, as a factor candidate that is likely to cause trouble, and outputs data indicating a relationship between values of the factor candidate in a specified period of time and the event data.

5. A quality analysis method, comprising:
acquiring quality data indicating a state of an object subjected to quality analysis and apparatus-information data indicating information of an apparatus that handles the object subjected to quality analysis;
setting data items of data to be counted up, a base condition indicating a condition that constitutes a basis of the quality analysis, and a comparison condition indicating a condition subjected to the quality analysis, with respect to the quality data and the apparatus-information data acquired in the data aggregation step; and
extracting from the quality data and the apparatus-information data acquired in the data aggregation step, data that meets the base condition and data that meets the comparison condition, for each data item set in the condition setting step, and calculating frequency distributions of these data for each of the data items, and outputting data indicating a degree of divergence for each of the data items between the frequency distribution of the base condition and the frequency distribution of the comparison condition.

6. The quality analysis device of claim 2,
wherein the processing circuitry sets the data items, the base condition and the comparison condition, in accordance with data items, a base condition and a comparison condition which are indicated from outside.

7. The quality analysis device of claim 2,
wherein the processing circuitry acquires event data indicating what event has occurred in relation to the apparatus,
the processing circuitry specifies the data item in which the degree of divergence is equal to or more than a set value, as a factor candidate that is likely to cause trouble, and outputs data indicating a relationship between values of the factor candidate in a specified period of time and the event data.
